(19) United States
(12) Patent Application Publication
(10) Pub. No.: US 2006/0070844 A1
(43) Pub. Date: Apr. 6, 2006

(54) Coin vault assembly having improved security

(76) Inventors: Pierre Lier, Branford, CT (US); David Bourez, Chester, CT (US)

Correspondence Address: CANTOR COLBURN, LLP, 55 GRIFFIN ROAD SOUTH, BLOOMFIELD, CT, 06002, US

(21) Appl. No.: 10/959,276

(22) Filed: Oct. 6, 2004

(51) Int. Cl. G07F 9/10

(52) U.S. Cl. 194/350

(57) ABSTRACT

Disclosed herein is a coin vault with improved security. The coin vault includes a housing and a coin drop assembly mounted to said housing. The coin drop is mounted to the housing including a mounting rod having a threaded end. Further disclosed is a coin vault having improved security wherein the coin vault includes a housing, a coin drop assembly platform having extended tabs thereon mounted to the housing. Yet further disclosed herein is a mounting rod for an improved security coin vault. The mounting rod is an elongated member with a threaded end at one end thereof. A failure point is provided in the rod spaced from the threaded end.

### BACKGROUND

Coin vault assemblies have been commercially used for many years in association with equipment intended to be “rented” for short time duration. Such equipment includes, for example, washing machines and dryers in Laundromats. Because such rentals generate cash that ends up in collection boxes (vernacularly termed “coin vaults”), the vaults themselves become a target for thieves. Those familiar with the usage of coin vault assemblies are painfully aware of the frequency at which such devices are tampered with and often defeated. Accompanying the material damage to the assembly in such instances is the direct loss of money, the theft of which is the object of the stated tampering. Quite often tampering involves the total loss of equipment related to the collection of money (for use of the attached device) meaning that the business owner is caused to expend more money to replace the damaged equipment, lose income while the device is non-functional and also, as noted above, lose the money that was in the collection device in the first place. Since the desire to steal and human ingenuity to succeed at the cause, no matter how nefarious the cause may be, remains pervasive in society, industries including the coin vault assembly industry continually require improved security measures and constructions.

### SUMMARY

Disclosed herein is a coin vault with improved security. The coin vault includes a housing and a coin drop assembly mounted to said housing. The coin drop is mounted to the housing including a mounting rod having a threaded end.

Further disclosed is a coin vault having improved security wherein the coin vault includes a housing, a coin drop assembly platform having extended tabs thereon mounted to the housing.

Yet further disclosed herein is a mounting rod for an improved security coin vault. The mounting rod is an elongated member with a threaded end at one end thereof. A failure point is provided in the rod spaced from the threaded end.

### BRIEF DESCRIPTION OF THE DRAWINGS

Referring now to the drawings wherein like elements are numbered alike in the several figures:

FIG. 1 is a perspective illustration of a portion of a coin vault of the prior art;

FIG. 2 is a perspective illustration of a portion of a coin vault according to this disclosure;

FIG. 3 is a perspective view of a mounting rod according to this disclosure; and

FIG. 4 is a cross-section of an assembled coin vault assembly according to this disclosure.

### DETAILED DESCRIPTION

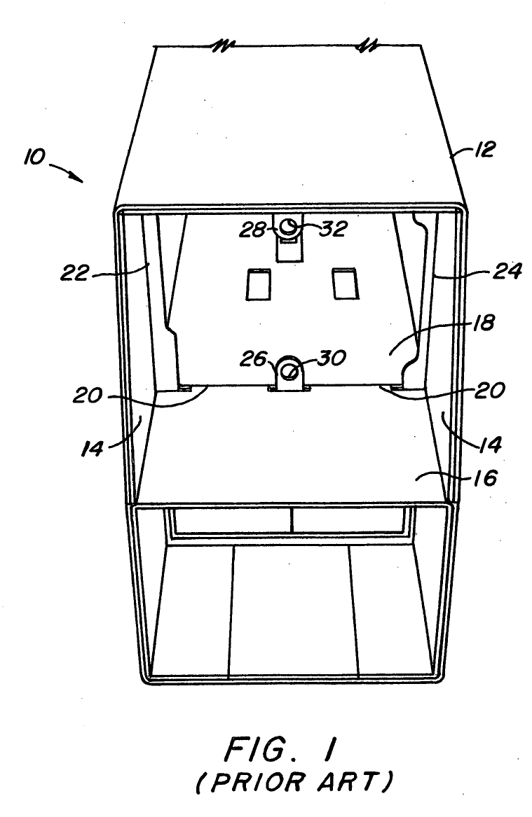

Referring to FIG. 1, a portion of a prior art coin vault is illustrated. The coin vault 10 comprises an outer housing 12, which may be metal or other strong material and an inner reinforcement plate 14. Also housed within outer housing 12 is a coin drop assembly platform 16. Platform 16 is adjacent a lock box cover 18. Platform 16 includes extensions 20 to extend over cover 18 to assist to maintain cover 18 in place. Side supports 22 and 24 are provided and mounting tabs 26 and 28 with mounting rod holes 30 and 32, respectively are provided.

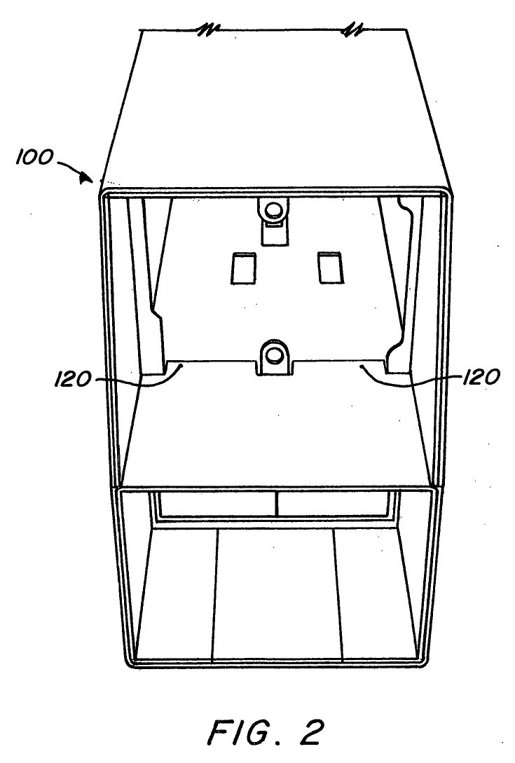

Referring to FIG. 2, each of the foregoing components are repeated except for extensions 20. According to the teaching herein, extensions 120 are incorporated into the coin vault 100 to enhance the security thereof. Prior art extensions 20 contribute to the defeatability of the coin vault because by their nature they allow the introduction of a prying implement that may be used to pry open the cover 18, thereby exposing the collected coins. By a comparative review of FIGS. 1 and 2 it will become apparent that the inventors hereof have devised a solution to the problem by configuring the extensions as shown in FIG. 2. Extensions 120 should extend over cover 18 by about 0.250″. By increasing the length of extensions 120, as illustrated, it is far more difficult for a would-be thief to access the cash box (not shown) by bending the cover 18 upwardly. This is because with the elongated extensions 120, the would-be thief cannot interpose a prying implement between the platform 16 and cover 18 to pry the cover upwardly. Without prying the cover upwardly, access to the cash box is prevented. In addition, the tabs may be welded to cover 18 whereafter strength is further enhanced.

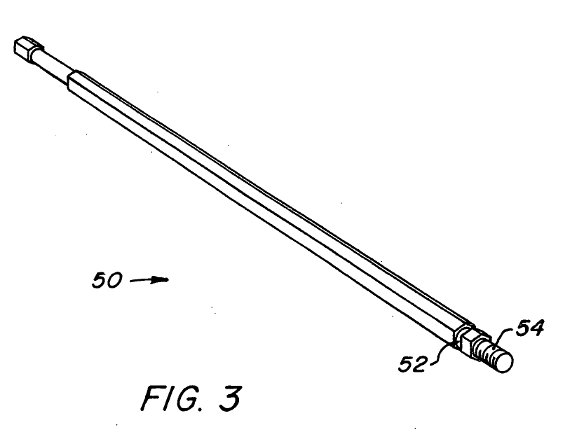

The security of a coin vault is additionally improved by utilizing mounting rods of a unique configuration as disclosed herein. The mounting rods according hereto are constructed to have a pre-engineered point of failure in bending so that the mounting rod will reliably break at a pre-selected point. Referring to FIG. 3, a mounting rod 50 is illustrated. One of skill will recognize the overall appearance of the mounting rod 50 from rods of the prior art but will also quickly notice that the rod 50 includes a groove 52 not known to the art. It is pointed out that the groove 52 is but one embodiment of a rod with a pre-selected point of failure. Other constructions are certainly possible; some examples are discussed hereinafter. An important concept with respect hereto is that the failure point of the rod must be somewhere along the rod that does not include the threaded portion of the rod. By so locating the failure point the mounting rod is better able to continue its job of retaining the coin drop in place providing that the failure point is positioned relative to a connection tab 26 or 28 that is on an opposing side of the connection tab from the side on which the coin drop is located. Effectively this causes the mounting rod to become a short screw or bolt in the event that a tampering action is undertaken against the coin vault and the mounting rod is broken (at the failure point). “Failure point” is intended with respect to this disclosure to be the generic term ascribed to the concept taught herein, the groove merely being one illustrated embodiment.

Still referring to FIG. 3, Groove 52 narrows the cross-sectional diameter of the mounting rod 50. At the location of groove 52 the cross-section of rod 50 is in one embodiment less than a cross-sectional diametric dimension of a thread area 54 of the mounting rod 50. By reducing the diameter of the rod 50 at groove 52 to below that of the thread area (at the root diameter thereof) there is a high probability that if the rod is placed in a condition subjecting it to bending, the rod will break at that location and not at the thread. This as noted above results in retention of the coin drop in the housing and consequently results in the failure of the attack on the coin vault by its assailant.

One of skill in the art should recognize following exposure to the foregoing that the purpose of groove 52 could be achieved alternately such as by creating a mounting rod 50 with alternate materials to ensure earlier breakage of the rod at the pre-selected area (even if there is no groove) than at the thread area.

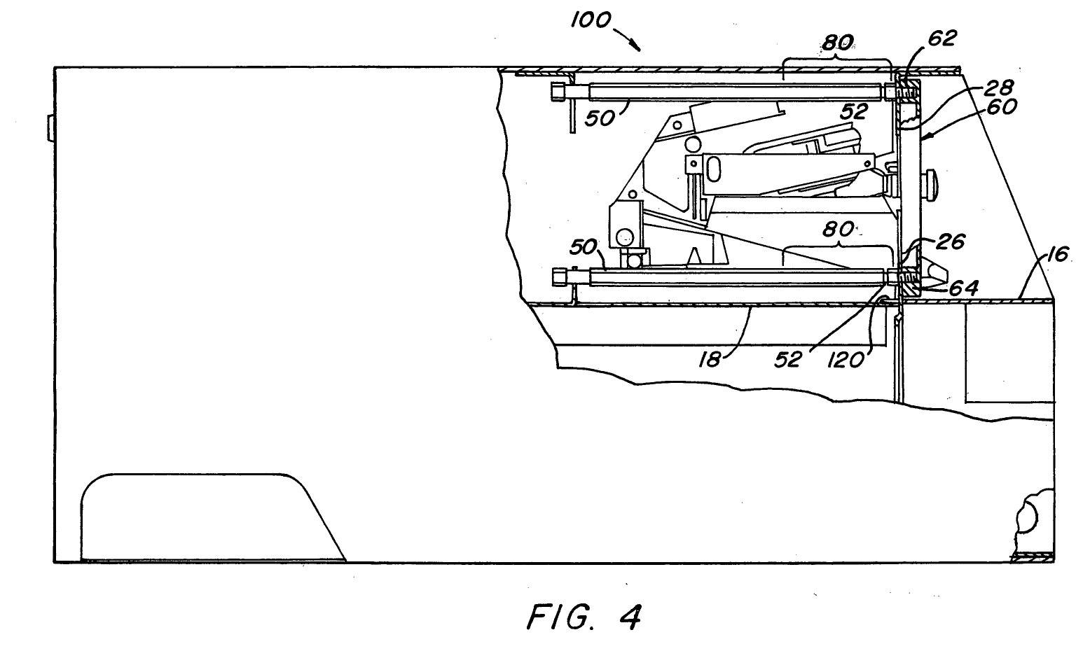

Referring to FIG. 4, a cross-sectional view of the coin vault is illustrated with the groove or other constructed failure point located “behind” the mounting tab 26. In one embodiment, this area is the area bracketed with numeral 80 (shown on both rods). By careful inspection of the drawing, one can see that the areas 80 are adjacent a surface of each of tabs 26 and 28 that opposes a surface of each of tabs 26 and 28 that is in contact with or is immediately adjacent to the coin drop assembly 60.

Mounting rod 50 is employed as mounting rods of the prior art were employed to hold a coin drop assembly 60 in position within housing 100. This is occasioned by the extension of rod 50 (two of them) through mounting tab 26 and 28, respectively. The threaded portion 54 of rod 50 fits through the openings 30 or 32 of tabs 26 or 28, respectively. The threaded portion 54 of rod 50 fits through the openings 30 or 32 of tabs 26 or 28, respectively and is threadably received in a tapped orifice 62 or 64 in the coin drop assembly 60. Because only the threaded position 54 fits through the openings 30 or 32, the failure point of the rod somewhere “behind” tabs 26 or 28 leaves the rod still capable of retaining the drop assembly 60 in place. Because the drop assembly is still in place, the time required to reach coins in the vault is greatly increased; the likelihood of success in reaching them diminished.

In addition to the foregoing illustrated embodiment of the failure point, it is further noted that the failure point may be simply a point on the rod where material strength is reduced. This may be occasioned by the use of plastic materials or alloys with controllable variable strength or other controlled configurations.

While preferred embodiments have been shown and described, modifications and substitutions may be made thereto without departing from the spirit and scope of the invention. Accordingly, it is to be understood that the present invention has been described by way of illustrations and not limitation.

1. A coin vault with improved security comprising:
a housing;
a coin drop assembly mounted to said housing;
a mounting rod having a threaded end; and
a failure point on the rod spaced from the threaded end, the mounting rod fixedly connecting the coin drop assembly to the housing.

2. A coin vault with improved security as claimed in claim 1 wherein the failure point is at a groove in the mounting rod.

3. A coin vault with improved security as claimed in claim 1 wherein the failure point is at a material section of the rod having lower strength than other areas of the rod.

4. A coin vault with improved security as claimed in claim 2 wherein the groove reduces a diameter of the rod to less than a diameter of the threaded end.

5. A coin vault having improved security comprising:
a housing; and
a coin drop assembly platform having extended tabs thereon mounted to the housing.

6. A coin vault having improved security as claimed in claim 5 wherein the tabs are welded to the housing.

7. A mounting rod for an improved security coin vault comprising:
an elongated member;
a threaded end at one end of the member; and
a failure point of the rod spaced from the threaded end.

8. A mounting rod for an improved security coin vault as claimed in claim 7 wherein the failure point is at a groove in the mounting rod.

9. A mounting rod for an improved security coin vault as claimed in claim 7 wherein the failure point is at a material section of the rod having lower strength than other areas of the rod.

10. A mounting rod for an improved security coin vault as claimed in claim 7 wherein the groove reduces a diameter of the rod to less than a diameter of the threaded end.
